(19) United States
(12) Patent Application Publication
(10) Pub. No.: US 2026/0222499 A1
(43) Pub. Date: Jul. 30, 2026

(54) INFORMATION MANAGEMENT SYSTEM

(71) Applicant: SEIKO EPSON CORPORATION, TOKYO (JP)

(72) Inventors: Akira NAKAZAWA, AZUMINO-SHI (JP); Shingo WAKI, MATSUMOTO-SHI (JP); Takao OIZUMI, MATSUMOTO-SHI (JP); Hiroki CHINO, MATSUMOTO-SHI (JP)

(21) Appl. No.: 19/460,560

(22) Filed: Jan. 27, 2026

(30) Foreign Application Priority Data
Jan. 27, 2025 (JP) 2025-011419

(51) Int. Cl. H04N 1/00

(52) U.S. Cl. CPC H04N 1/00331; H04N 1/00238; H04N 1/00244; H04N 1/00822

(57) ABSTRACT

An information management system includes: a reading unit that reads an image on a medium including personal information; an OCR function unit that converts data of the image read by the reading unit into text data; an information list generation unit that extracts contents corresponding to a plurality of items prescribed in advance from the text data and generates an information list including the plurality of items and the contents; a storage unit that stores the information list; and a control unit that controls operations of the reading unit, the OCR function unit, the information list generation unit, and the storage unit to generate the information list.

The present application is based on, and claims priority from JP Application Serial Number 2025-011419, filed January 27, 2025, the disclosure of which is hereby incorporated by reference herein in its entirety.

### BACKGROUND

### 1. Technical Field

The present disclosure relates to an information management system.

### 2. Related Art

Examples of the related art for this type of device include those described in JP-A-2006-72478 and JP-A-2018-170582.

JP-A-2006-72478 discloses a disaster survivor checking system in which personal information recorded in an IC tag (recording medium) is read by an IC tag reading device and in which the personal information and evacuation place information are transmitted from a personal computer (PC) (shelter, hospital) to a computer system (headquarters for disaster control).

JP-A-2018-170582 discloses an image forming device disposed in a shelter. JP-A-2018-170582 discloses that the image forming device reads and acquires, via an acquisition unit, personal information in the form of a two-dimensional code stored in advance in a smartphone, and registers the personal information in a registration unit of an image reading device.

JP-A-2006-72478 and JP-A-2018-170582 are examples of the related art.

However, in the system disclosed in JP-A-2006-72478, only an IC tag is valid, and when an evacuee does not have an IC tag, disaster survivor information cannot be acquired. Also, a reading device for reading the IC tag is separately required in addition to the PC.

In the image forming device disclosed in JP-A-2018-170582, personal information in the form of a two-dimensional code needs to be stored in a smartphone in advance. In this case, when the evacuee does not have personal information in the form of a two-dimensional code, it is difficult to acquire the personal information. Also, when the personal information is not updated, outdated and wrong personal information is acquired.

### SUMMARY

According to an aspect of the present disclosure, an information management system includes: a reading unit that reads an image on a medium including personal information; an OCR function unit that converts data of the image read by the reading unit into text data; an information list generation unit that extracts contents corresponding to a plurality of items prescribed in advance from the text data and generates an information list including the plurality of items and the contents; a storage unit that stores the information list; and a control unit that controls operations of the reading unit, the OCR function unit, the information list generation unit, and the storage unit to generate the information list.

### BRIEF DESCRIPTION OF THE DRAWINGS

FIG. 1 is a schematic front view of an information management system according to Embodiment 1.

FIG. 2 is a block configuration view of a main part shown in FIG. 1.

FIG. 3 is a flowchart illustrating generation of an information list by a control unit according to Embodiment 1.

FIG. 4 shows an example of the information list according to Embodiment 1.

FIG. 5 is a flowchart illustrating a control flow by a control unit according to Embodiment 2.

FIG. 6 shows an example of an unknown person list according to Embodiment 2.

FIG. 7 is a schematic front view of an information management system according to another embodiment.

### DESCRIPTION OF EMBODIMENTS

First, an overview of the present disclosure will be described.

According to a first aspect of the present disclosure, an information management system includes: a reading unit that reads an image on a medium including personal information; an OCR function unit that converts data of the image read by the reading unit into text data; an information list generation unit that extracts contents corresponding to a plurality of items prescribed in advance from the text data and generates an information list including the plurality of items and the contents; a storage unit that stores the information list; and a control unit that controls operations of the reading unit, the OCR function unit, the information list generation unit, and the storage unit to generate the information list.

According to this aspect, the information management system includes the OCR function unit that converts the data of the image read by the reading unit into text data. The information list generation unit is configured to extract contents corresponding to a plurality of items prescribed in advance from the text data and generate an information list including the plurality of items and the contents. Thus, since the image data is converted into the text data by the OCR function unit, an information source is not limited to the IC tag or the two-dimensional code as in the related art in acquiring and listing the personal information. Therefore, the personal information can be easily listed. Also, since the information list is stored in the storage unit, the personal information can be easily viewed and searched. That is, the personal information can be effectively used for disaster evacuation support such as checking of safety status and calculation of a necessary amount of relief supplies.

Here, the "plurality of items prescribed in advance" are name, age, gender, address, and the like that can identify an individual.

According to a second aspect of the present disclosure, in the information management system according to the first aspect, the control unit has a fixed list form including the plurality of items, and generates the information list by entering the contents in the fixed list form.

According to this aspect, the control unit is configured to generate the information list by entering the contents in the fixed list form. That is, the contents are described in the standardized fixed list form and the information list is thus generated. Thus, even when the media including the personal information are different from each other, the information list is generated, based on the standardized fixed list form, and therefore the listing processing is easy and the generated information list is standardized and easy to view and use.

According to a third aspect of the present disclosure, in the information management system according to the first aspect, the reading unit is able to simultaneously read a plurality of the media, and when the reading unit simultaneously reads the plurality of media, the control unit generates the information list, based on image data on the plurality of media as a group.

Note that this aspect can also be dependent on the second aspect.

For example, the list is easier to manage and easier to use when one family forms one group and the information thereof is listed than when the information of each member of the family is listed individually.

According to this aspect, the control unit is configured to, when the reading unit simultaneously reads a plurality of the media, generate the information list, based on image data on the plurality of media as a group. Thus, the list is easy to manage, easy to use, and easy to view and search.

According to a fourth aspect of the present disclosure, in the information management system according to the first aspect, the control unit is able to switch between an emergency use mode and a normal use mode, and generates the information list based on reading of the personal information by the reading unit when the emergency use mode is selected.

Note that this aspect can also be dependent on the second aspect or the third aspect.

According to this aspect, since switching between the emergency use mode and the normal use mode can be made, the information list of personal information is generated by selecting to switch to the emergency use mode in an emergency where a disaster such as an earthquake occurs and many people evacuate to shelters. That is, the information list of personal information is generated only in an emergency. Thus, the risk of unintentional spread of personal information can be reduced.

According to a fifth aspect of the present disclosure, the information management system according to the first aspect further includes a printing unit that is able to print a fixed list form including the plurality of items, and the control unit reads, with the reading unit, the fixed list form printed by the printing unit in a state where the contents are entered as the plurality of items, and generates the information list.

Note that this aspect can also be dependent on any one of the second to fourth aspects.

According to this aspect, even when an evacuee does not have a personal certificate such as a driver's license or a health insurance card, the information list can be generated by describing a name, an address, or the like in the fixed list form printed by the printing unit and causing the reading unit to read the fixed list form.

According to a sixth aspect of the present disclosure, the information management system according to the first aspect further includes an operation panel that is able to input the contents, and the control unit generates the information list, based on the contents input from the operation panel.

Note that this aspect can also be dependent on any one of the second to fifth aspects.

When there is a large damage or stain on a personal certificate or the like such as a driver's license or a health insurance card carried by an evacuee, the reading unit may not be able to read necessary information.

According to this aspect, the control unit is configured to generate the information list, based on the contents input from the operation panel. Thus, even when necessary information cannot be read due to a damage or stain on a driver's license or the like carried by an evacuee, the information list can be generated by inputting the contents from the operation panel.

According to a seventh aspect of the present disclosure, the information management system according to the first aspect further includes a printing unit that is able to print the information list stored in the storage unit.

Note that this aspect can also be dependent on any one of the second to sixth aspects.

According to this aspect, since the printing unit that is able to print the information list stored in the storage unit is provided, the information list can be printed without using another device such as a personal computer, and this provides user-friendliness.

According to an eighth aspect of the present disclosure, the information management system according to the first aspect further includes a communicably coupled server device, and the server device saves the information list stored in the storage unit into a data saving unit when receiving the information list.

Note that this aspect can also be dependent on any one of the second to seventh aspects.

According to this aspect, the communicably coupled server device is configured to save the information list stored in the storage unit into the data saving unit when receiving the information list. Thus, when the server device is placed at the headquarters for disaster control, the headquarters for disaster control can grasp the status of each shelter from the information list generated at a plurality of shelters, and disaster control measures can be taken according to each shelter.

According to a ninth aspect of the present disclosure, in the information management system according to the eighth aspect, the server device is able to use resident data, collates the information list with the resident data, and generates an unknown person list of residents who are not listed in the information list.

According to this aspect, the server device is configured to collate the information list with the resident data and generate an unknown person list of residents who are not listed in the information list. Thus, an unknown person can be easily identified.

According to a tenth aspect of the present disclosure, in the information management system according to the eighth aspect, the information list can be deleted from the storage unit after the information list is saved in the data saving unit.

Note that this aspect can also be dependent on the ninth aspect.

According to this aspect, after the information list is saved in the data saving unit, the information list can be deleted from the storage unit. Thus, the risk of leakage of personal information can be reduced.

### Embodiments

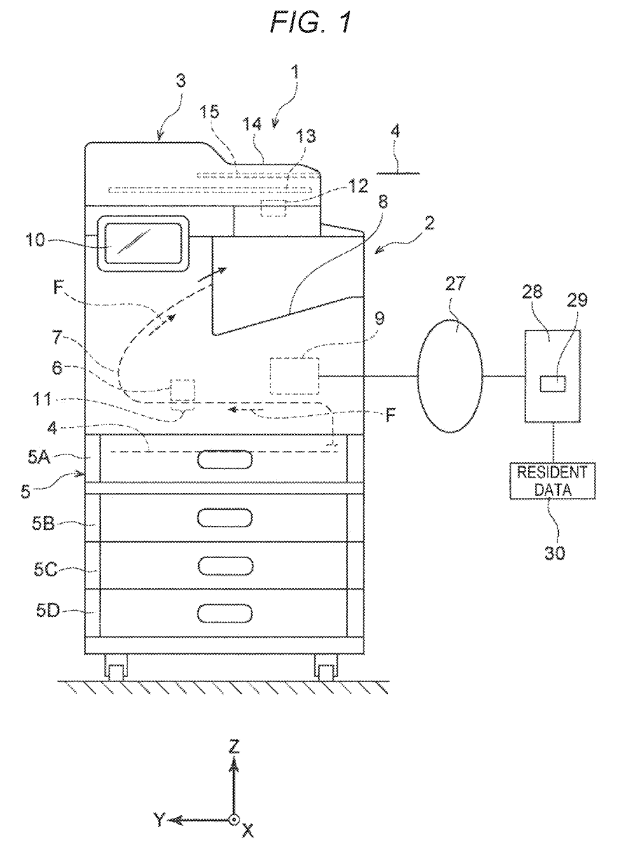

Hereinafter, an embodiment of an information management system according to the present disclosure will be specifically described with reference to FIGS. 1 to 7.

An information management system 1 according to the present embodiment includes an image forming device 2 and an image reading device 3. The image reading device 3 is provided at an upper part of the image forming device 2.

In the description below, three axes orthogonal to one another are respectively defined as an X axis, a Y axis, and a Z axis as illustrated in the illustrations. A direction indicated by an arrow along the three axes (X, Y, and Z) is a + direction along the axes, and the opposite direction thereof is a - direction. The Z-axis direction is equivalent to a vertical direction, that is, a direction in which the gravity acts, the +Z direction indicates a vertically upward direction and the -Z direction indicates a vertically downward direction. The X-axis direction and the Y-axis direction correspond to a horizontal direction. The +Y direction indicates a left direction of the image forming device 2 and the image reading device 3, and the -Y direction indicates a right direction of the devices. The +X direction indicates a front direction of the devices, and the -X direction indicates a rear direction of the devices.

### Schematic Configuration of Image Forming Device

A schematic structure of the image forming device 2 will be described with reference to FIG. 1. Here, the image forming device 2 is an inkjet printer.

The image forming device 2 includes a medium accommodation unit 5 in which a medium 4 such as paper is accommodated, a printing unit 6 including a line head or the like that performs printing by ejecting an ink onto the medium 4, a conveyance unit, not illustrated, including a conveyance roller or the like that conveys the medium 4, a conveyance path 7 that is a path through which the medium 4 is conveyed in a conveyance direction F, a discharge tray 8, a control unit 9, and an operation panel 10.

The control unit 9 controls the operations of the entirety of the image forming device 2 and the image reading device 3, described later. The operation panel 10 functions as a display unit that accepts various setting operations and displays various information.

Here, the medium accommodation unit 5 includes four medium cassettes 5A, 5B, 5C, and 5D. The medium 4 is sent out from each of the medium cassettes 5A, 5B, 5C, and 5D to the conveyance path 7 by the conveyance unit, and is further conveyed in the conveyance direction F through the conveyance path 7.

The medium 4 is conveyed through the conveyance path 7 by the conveyance unit and printed in a print execution area 11 of the printing unit 6, and the printed medium 4 is discharged to the discharge tray 8.

### Schematic Structure of Image Reading device

A schematic structure of the image reading device 3 will be described with reference to FIG. 1. Here, the image reading device 3 is a scanner that can read an image on the medium 4 serving as a document. The image refers to what is visually recorded on the medium 4, for example, a character, a geometric shape, a table, a picture, and a photograph. The medium 4 is not limited to a sheet, and includes a card, a booklet, and the like.

The image reading device 3 includes a reading unit 12 and a document table 13. The reading unit 12 is a CIS or CCD image sensor. The reading unit 12 reads an image by moving in the Y-axis direction along a surface of the medium 4 in a state where the medium 4 serving as a document is placed on the document table 13.

The image reading device 3 includes an automatic document conveyance unit 14. The medium 4 set in a document setting unit 15 of the automatic document conveyance unit 14 is also conveyed toward a reading position of another reading unit, not illustrated, by another conveyance unit, not illustrated, and an image thereon is read.

### Embodiment 1

Following the above description of the overall structure of the image forming device 2 and the image reading device 3 forming the information management system 1, the information management system 1 according to Embodiment 1 will be described below with reference to FIGS. 1 to 4.

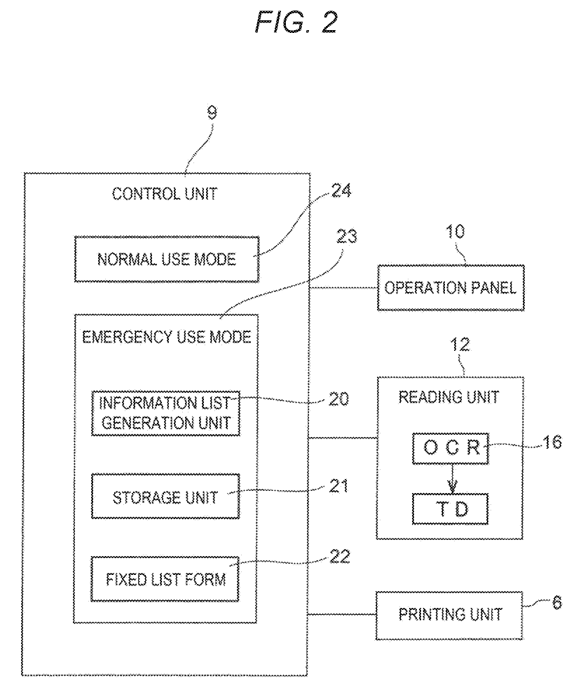

As illustrated in FIGS. 1 and 2, the information management system 1 according to Embodiment 1 includes the reading unit 12, an OCR function unit 16, an information list generation unit 20, a storage unit 21, and the control unit 9. The information management system 1 according to the present embodiment is, for example, a multifunction printer.

The reading unit 12 reads an image on the medium 4 including personal information. Here, the personal information is information necessary for identifying an individual, and includes a name, an age, a gender, an address, and the like. Examples of the medium 4 including personal information include a driver's license, a health insurance card, an individual number card (ID card), a passport, and the like. The medium 4 is placed on the document table 13 (FIG. 1), and an image thereon is read.

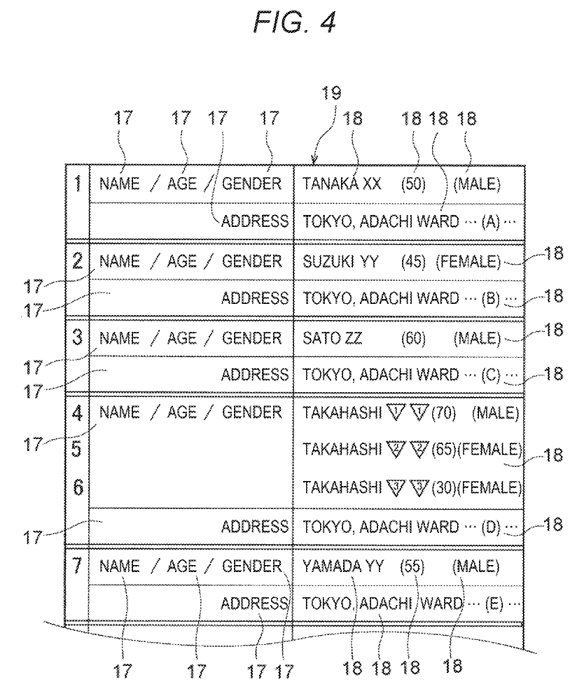

The OCR function unit 16 converts data of the image read by the reading unit 12 into text data TD. As the data of the image is converted into the text data TD, editing can be performed and the generation of an information list 19 (FIG. 4) in which personal information is collected, that is, the creation of the information list 19, can be performed. In the present embodiment, the reading unit 12 includes the OCR function unit 16.

The information list generation unit 20 generates the information list 19 illustrated in FIG. 4 as an example. That is, the information list generation unit 20 extracts contents 18, 18, ... corresponding to a plurality of items 17, 17, ... prescribed in advance from the text data TD, and generates the information list 19 including the plurality of items 17, 17, ... and the contents 18, 18, ... . Here, the plurality of items 17, 17, ... are the name, age, gender, and address, of the personal information. The contents 18, 18, ... corresponding to the items 17, 17, ... are "Tanaka XX (50) (male)" and "Tokyo, Adachi Ward ... (A) ..." in the first row of the information list 19, and "Suzuki YY (45) (female)" and "Tokyo, Adachi Ward ... (B) ..." in the second row of the information list 19.

The storage unit 21 stores the information list 19 generated by the information list generation unit 20.

The control unit 9 is configured to control operations of the reading unit 12, the OCR function unit 16, the information list generation unit 20, and the storage unit 21 to generate the information list 19, and store the generated information list 19 in the storage unit 21.

The control unit 9 includes a CPU, a flash ROM, and a RAM. The CPU performs various types of arithmetic processing according to programs stored in the flash ROM, and controls the operations of the entirety of the image forming device 2 and the image reading device 3. The flash ROM, which is an example of a storage section, is a readable and writable nonvolatile memory. The RAM, which is an example of a storage section, temporarily stores various information.

In the present embodiment, as illustrated in FIG. 2, the control unit 9 includes the information list generation unit 20 and the storage unit 21, and is electrically coupled to the reading unit 12, the operation panel 10, and the printing unit 6.

As illustrated in FIG. 2, in the present embodiment, the control unit 9 has an emergency use mode 23 and a normal use mode 24 in a switchable manner.

The emergency use mode 23 is a control mode dedicated for emergency in which the operations of the image forming device 2 and the image reading device 3 installed in a shelter are controlled in an emergency where a disaster such as an earthquake occurs and many people evacuate to the shelter. The normal use mode is a control mode in which the operations of the image forming device 2 and the image reading device are controlled when in a normal state, which is not an emergency.

The control unit 9 is configured to generate the information list 19, based on the reading of the image on the medium 4 including the personal information by the reading unit 12, when the emergency use mode 23 is selected. Here, the emergency use mode 23 can be selected via the operation panel 10.

In the present embodiment, as shown in FIG. 2, the control unit 9 has a fixed list form 22 including the plurality of items 17. The fixed list form 22 corresponds to a list of blank states before the contents 18 are written, in FIG. 4. Of course, the fixed list form 22 is not limited to the form shown in FIG. 4.

Then, the control unit 9 is configured to convert the data of the image read by the reading unit 12 into the text data TD, extract the contents 18 corresponding to the plurality of items 17, write the extracted contents 18 in blank spaces in the fixed list form 22, and thus generate the information list 19.

In the present embodiment, as illustrated in FIG. 1, the reading unit 12 can simultaneously read a plurality of media 4, 4, … placed on the document table 13. As illustrated in FIG. 4, when the reading unit 12 simultaneously reads the plurality of media 4, 4, ..., the control unit 9 generates the information list 19, based on the image data on the plurality of media 4, 4, ... as a group.

The three persons from the fourth to sixth in the information list 19 are a family. When members of a family are grouped and listed as one group, one row suffices as the address field, and the list is easy to manage and easy to use. Therefore, as illustrated in FIG. 4, the control unit 9 is configured to generate the information list 19 in which a family or the like is regarded as one group.

In the present embodiment, as illustrated in FIGS. 1 and 2, the printing unit 6 can print the fixed list form 22 including the plurality of items 17. An evacuee may not possess the medium 4 including personal information such as a driver's license. Even in this case, the information list 19 can be generated by printing the fixed list form 22, writing the contents 18, 18, ... corresponding to the plurality of items 17, 17, ... in the printed fixed list form 22, and causing the reading unit 12 to read the image.

That is, the control unit 9 is configured to generate the information list 19 by reading, with the reading unit 12, the fixed list form 22 printed by the printing unit 6 in a state in which the contents 18, 18, ... are written in the plurality of items 17, 17, ... .

Also, in the present embodiment, the printing unit 6 can print the information list 19 stored in the storage unit 21. That is, the control unit 9 is configured to be able to print the information list 19 stored in the storage unit 21, by the printing unit 6.

In the present embodiment, the operation panel 10 is configured to be able to directly input the contents 18, 18, ... of the personal information corresponding to the plurality of items 17, 17, ... . That is, the contents 18, 18, ... can be directly input without using the reading unit 12. Specifically, the plurality of items 17 are displayed on the operation screen of the operation panel 10, and the evacuee inputs the corresponding content 18 according to the displayed items 17.

The control unit 9 generates the information list 19, based on the contents 18, 18, ... input from the operation panel 10. That is, the information list 19 is basically generated via the reading unit 12 and the OCR function unit 16, and can be generated without using the reading unit 12 and the OCR function unit 16.

### Description of Generation of Information List According to Embodiment 1

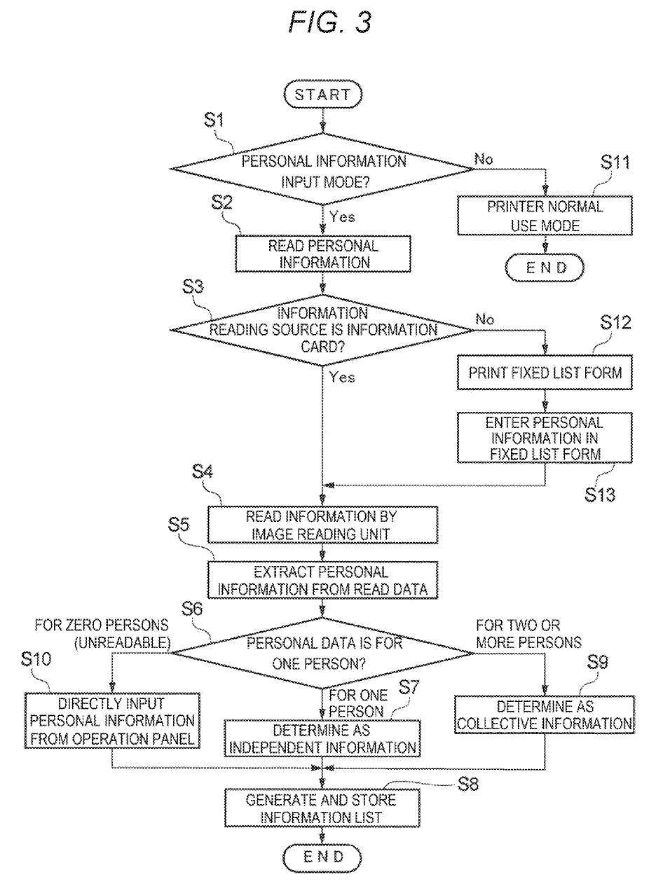

The generation of the information list by the information management system according to Embodiment 1 will be described with reference to FIG. 3.

In step S1, the control unit 9 determines whether a personal information input mode is set. That is, whether the emergency use mode 23 is selected instead of the normal use mode 24 is determined. When the emergency use mode 23 is selected (Yes), the processing proceeds to step S2 and the mode is switched to the emergency use mode 23. In step S3, whether the information reading source is an information card such as a driver's license is determined.

When the information reading source is an information card (Yes), the processing proceeds to step S4, and the reading unit 12 reads an image to acquire data of the image. The processing further proceeds to step S5, in which the data of the read image is converted into the text data TD by the OCR function unit 16, and the content 18 of the personal information is extracted.

Subsequently, the processing proceeds to step S6, and whether the personal data is for one person is determined. When the personal data is for one person, it is determined in step S7 that the personal data is independent information. Subsequently, the processing proceeds to step S8 and the information list 19 is generated. Also, the generated information list 19 is stored in the storage unit 21. Subsequently, the processing returns to START and waits to accept the next personal information.

When the personal data is for two or more persons in step S6, the processing proceeds to step S9, and in this case, it is determined that the personal data is collective information of a family or the like. Subsequently, the processing proceeds to step S8, and the control unit 9 generates the information list 19, based on each group.

That is, as shown in the fourth to sixth sections in FIG. 4, the information of these persons is listed as one group and stored in the storage unit 21. Subsequently, the processing returns to START and waits to accept the next personal information.

When it is determined in step S6 that the personal data is for zero persons, it is determined that the reading by the reading unit 12 cannot be performed, and the processing proceeds to step S10. Here, that the reading by the reading unit 12 cannot be performed means that the reading unit 12 cannot read the contents 18, 18, ... corresponding to the plurality of items 17, 17, ... from the information card which is the information reading source. This may occur due to damage, stain, or the like on the information card.

In step 10, the information list 19 is generated, based on the contents 18, 18, ... input from the operation panel 10. In this case, the processing may proceed to step S12, described later.

When the emergency use mode 23 is not selected (No) in step S1, the processing proceeds to step S11, and the image forming device 2 and the image reading device 3 remain in the default normal use mode 24.

When the evacuee does not have an information card such as a driver's license in step S3 (No), the processing proceeds to step S12. In step S12, the printing unit 6 is made to print the fixed list form 22. Subsequently, the processing proceeds to step S13, and an instruction to create the printed fixed list form 22 in which the contents 18,18, ... such as the name are described in a blank space is given. The processing proceeds to step S4, using the fixed list form 22 in which the contents 18, 18, ... such as the name are described in the blank space.

### Description of Effects of Embodiment 1

(1) In the present embodiment, the OCR function unit 16 that converts data of an image read by the reading unit 12 into text data TD is provided. Then, the information list generation unit 20 is configured to extract contents 18, 18, ... corresponding to a plurality of items 17, 17, ... prescribed in advance from the text data TD, and generate the information list 19 including the plurality of items 17, 17, ... and the contents 18, 18, ... . Thus, since the image data read by the reading unit 12 is converted into the text data TD by the OCR function unit 16, the information source is not limited to an IC tag or a two-dimensional code as in the related art when acquiring and listing the personal information. Thus, the personal information can be easily listed. Also, since the information list 19 is stored in the storage unit 21, the personal information can be easily viewed and searched. That is, the personal information can be effectively used for disaster evacuation support such as checking of safety status and calculation of a necessary amount of relief supplies.

(2) In the present embodiment, the control unit 9 is configured to generate the information list 19 by entering the contents 18, 18, ... in the fixed list form 22. That is, the contents 18, 18, ... are entered in the standardized fixed list form 22, and the information list 19 is thus generated. Thus, even when the media 4 including the personal information are different from each other, the information list 19 is generated, based on the standardized fixed list form 22, therefore the listing processing is easy and the generated information list 19 is standardized and easy to view and use.

(3) For example, the list is easier to manage and easier to use when one family forms one group and the information thereof is listed than when the information of each member of the family is listed individually.

In the present embodiment, when the reading unit 12 simultaneously reads the plurality of media 4, 4, ..., the control unit 9 generates the information list 19, based on the image data on the plurality of media 4, 4, ... as a group. Thus, the list is easy to manage, easy to use, and easy to view and search.

(4) Also, in the present embodiment, since switching between the emergency use mode 23 and the normal use mode 24 can be made, the information list 19 of personal information is generated by selecting to switch to the emergency use mode 23 in an emergency where a disaster such as an earthquake occurs and many people evacuate to shelters. That is, the information list 19 of personal information is generated only in an emergency. Thus, the risk of unintentional spread of personal information can be reduced.

(5) Also, in the present embodiment, even when an evacuee does not have a personal certificate such as a driver's license or a health insurance card, the information list 19 can be generated by describing a name, an address, or the like in the fixed list form 22 printed by the printing unit 6 and causing the reading unit 12 to read the fixed list form 22.

(6) When there is a large damage or stain on a personal certificate or the like such as a driver's license or a health insurance card carried by an evacuee, the reading unit 12 may not be able to read necessary information.

In the present embodiment, the control unit 9 is configured to generate the information list 19, based on the contents 18, 18, ... input from the operation panel 10. Thus, even when necessary information cannot be read due to a damage or stain on a driver's license or the like carried by an evacuee, the information list 19 can be generated by inputting the contents 18, 18, ... from the operation panel 10.

(7) Also, in the present embodiment, since the printing unit 6 that is able to print the information list 19 stored in the storage unit 21 is provided, the information list 19 can be printed without using another device such as a personal computer, and this provides user-friendliness.

### Embodiment 2

Next, an information management system 1 according to Embodiment 2 will be described with reference to FIGS. 1, 5, and 6. The same parts as in Embodiment 1 are denoted by the same reference numerals and signs, and the description of the configurations of the parts and effects corresponding to the configurations is omitted.

As illustrated in FIG. 1, in the present embodiment, the information management system 1 further includes a communicably coupled server device 28. The server device 28 is installed at a headquarters for disaster control or the like at a location different from the shelter. The server device 28 is communicably coupled to the control unit 9 via a communication function unit 27 such as the internet.

The server device 28 is configured to save the information list 19 stored in the storage unit 21 into a data saving unit 29 when receiving the information list 19. The reception of the information list 19 by the server device 28 may be performed by either a method of proactively transmitting the information list 19 from the control unit 9 to the server device 28 or a method of transmitting the information list 19 in response to a request from the server device 28.

As illustrated in FIG. 1, in the present embodiment, the server device 28 is configured to be able to use resident data 30. The server device 28 is configured to collate the information list 19 with the resident data 30 and generate an unknown person list 31 of residents who are not listed in the information list 19.

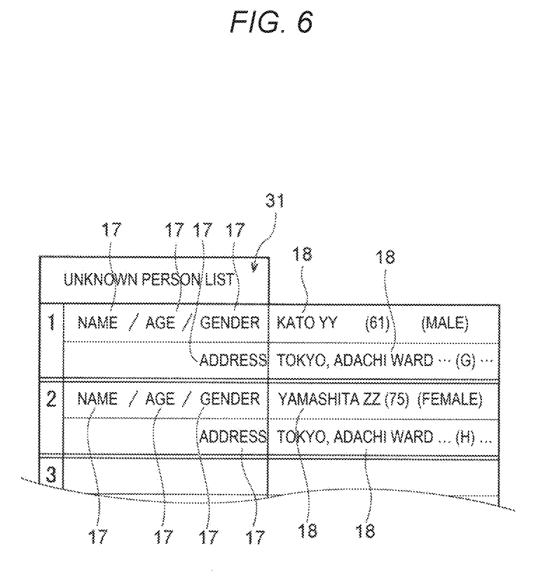

FIG. 6 shows an example of the unknown person list 31. In the unknown person list 31 illustrated in FIG. 6, each content 18 corresponding to each item 17 is extracted from the resident data 30, based on the collation between the information list 19 and the resident data 30.

Also, the server device 28 may be coupled to a printer, not illustrated, and the unknown person list 31 may be printed by the printer.

In the present embodiment, after the server device 28 saves the information list 19 in the data saving unit 29, the information list 19 can be deleted from the storage unit 21 of the control unit 9.

### Description of Control Flow in Embodiment 2

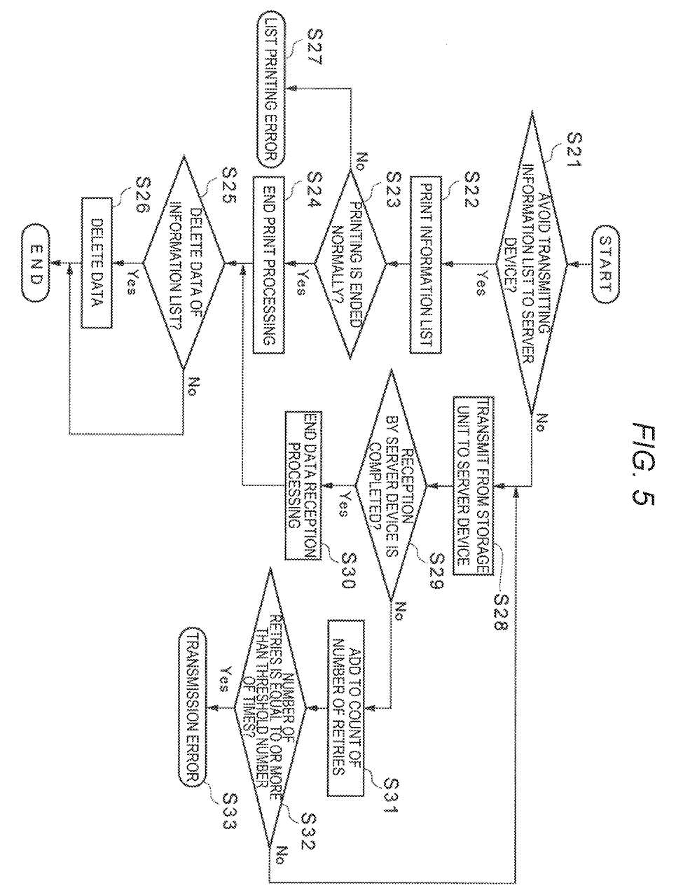

A control flow in the information management system according to Embodiment 2 will be described with reference to FIG. 5.

In the present embodiment, in step S21, the control unit 9 determines whether to avoid transmitting the generated information list 19 to the server device 28. This determination is performed according to the state of the server device 28 or the state of the control unit 9 itself. When it is determined that the transmission is avoided (Yes), the processing proceeds to step S22, and the printing unit 6 is made to print the information list 19. From the viewpoint of protection of personal information, it is desirable to provide an authentication function and request authentication check when causing the printing unit 6 to print the information list 19.

Subsequently, in step S23, whether the printing is normally done is determined, and when the printing is normally done (Yes), the processing proceeds to step S24 and the print processing ends. Subsequently, the processing proceeds to step S25. In step S25, whether to delete the information list 19 from the storage unit 21 is determined. This determination is performed, based on an instruction signal transmitted from the server device 28. When an instruction to delete is given (Yes), the processing proceeds to step S26, the data of the information list 19 is deleted from the storage unit 21 and the processing ends (END).

When the printing is not normally done (No) in step S23, the processing proceeds to step S27, this situation is defined as a list printing error such that the user can understand that.

When it is determined in step S21 that the generated information list 19 is to be transmitted to the server device 28 (No), the processing proceeds to step S28. In step S28, the information list 19 is transmitted from the storage unit 21 to the server device 28. Subsequently, the processing proceeds to step S29, and whether the reception of the information list 19 by the server device 28 is completed is determined. When the reception is completed (Yes), the processing proceeds to step S30 and the data reception processing ends. Subsequently, the processing proceeds to step S25.

Note that, after step S30, separately from the flow that proceeds to step S25, the information list 19 and the resident data 30 are collated with each other to generate the unknown person list 31, though not illustrated.

When the reception is not completed (No) in step S29, the processing proceeds to step S31, and 1 is added to the count of the number of retries as another round of reception processing. Then, the processing proceeds to step S32, and whether the number of retries is equal to or more than a threshold number of times is determined. When the number of retries is equal to or more than the threshold number of times (Yes), the processing proceeds to step S33 and this situation is defined as a transmission error such that the user can understand that. When the number of retries is not equal to or more than the threshold number of times (No) in step S32, the processing returns to step S28.

### Description of Effects of Embodiment 2

(1) In the present embodiment, the server device 28 coupled to be communicable via the internet or the like is configured to save the information list 19 stored in the storage unit 21 into the data saving unit 29 when receiving the information list 19. Thus, when the server device 28 is placed at the headquarters for disaster control, the headquarters for disaster control can grasp the status of each shelter from the information list 19 generated at a plurality of shelters, and disaster control measures can be taken according to each shelter.

(2) Also, in the present embodiment, the server device 28 is configured to collate the information list 19 with the resident data 30 and generate an unknown person list 31 of residents who are not listed in the information list 19. Thus, an unknown person can be easily identified.

(3) In the present embodiment, after the information list 19 is saved in the data saving unit 29, the information list 19 can be deleted from the storage unit 21. Thus, the risk of leakage of personal information can be reduced.

### Other Embodiments

The information management system 1 according to the present disclosure basically has the configurations of the above-described embodiments, but as a matter of course, changes, omissions, and the like of some parts of the configurations can be made without departing from the scope of the present disclosure.

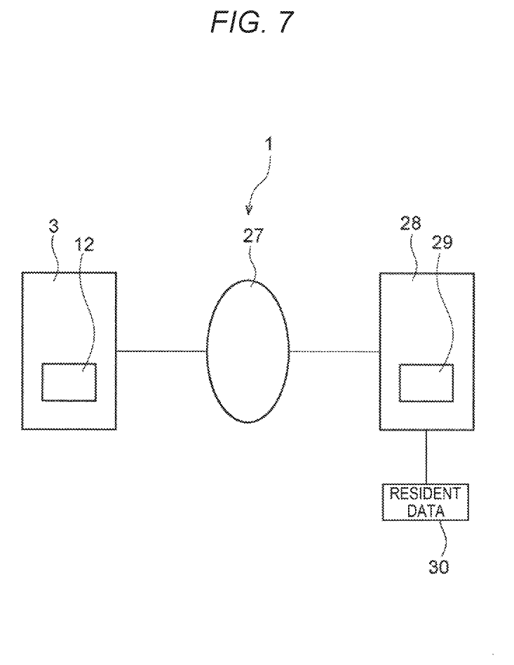

FIG. 7 illustrates a state where the control unit 9, not illustrated, in the image reading device 3 and the server device 28 are coupled to be communicable via the communication function unit 27 such as the internet.

In the above embodiments, the information management system 1 includes the image forming device 2 and the image reading device 3. However, as illustrated in FIG. 7, only the image reading device 3 may be provided without having the image forming device 2. That is, the image reading device 3 may include the reading unit 12, the OCR function unit 16, the information list generation unit 20, and the storage unit 21, and may also include the control unit 9 that controls operations of the reading unit 12, the OCR function unit 16, the information list generation unit 20, and the storage unit 21 to generate the information list 19.

The information management system 1 may include the image reading device 3 and the server device 28 that is able to communicate with the image reading device 3, and may have a configuration including the reading unit 12, the OCR function unit 16, the information list generation unit 20, and the storage unit 21.

In this configuration, the image reading device 3 may include the reading unit 12, and the server device 28 may include the OCR function unit 16, the information list generation unit 20, and the storage unit 21.

The image reading device 3 may include the reading unit 12 and the OCR function unit 16, and the server device 28 may include the information list generation unit 20 and the storage unit 21.

The image reading device 3 may include the reading unit 12, the OCR function unit 16, and the information list generation unit 20, and the server device 28 may include the storage unit 21.

With these configurations, effects similar to the above effects can be achieved.

What is claimed is:

1. An information management system comprising:
a reading unit configured to read an image on a medium including personal information;
an OCR function unit configured to convert data of the image read by the reading unit into text data;
an information list generation unit configured to extract contents corresponding to a plurality of items prescribed in advance from the text data and generate an information list including the plurality of items and the contents;
a storage unit configured to store the information list; and
a control unit configured to control operations of the reading unit, the OCR function unit, the information list generation unit, and the storage unit to generate the information list.

2. The information management system according to claim 1, wherein
the control unit
has a fixed list form including the plurality of items, and
generates the information list by entering the contents in the fixed list form.

3. The information management system according to claim 1, wherein
the reading unit is configured to be able to simultaneously read a plurality of the media, and
when the reading unit simultaneously reads the plurality of media, the control unit generates the information list, based on image data on the plurality of media as a group.

4. The information management system according to claim 1, wherein
the control unit
is configured to be able to switch between an emergency use mode and a normal use mode, and
generates the information list, based on reading of the image on the medium including the personal information by the reading unit when the emergency use mode is selected.

5. The information management system according to claim 1, further comprising:
a printing unit configured to be able to print a fixed list form including the plurality of items, wherein
the control unit reads, with the reading unit, the fixed list form printed by the printing unit in a state where the contents are entered as the plurality of items, and generates the information list.

6. The information management system according to claim 1, further comprising:
an operation panel configured to be able to input the contents, wherein
the control unit generates the information list, based on the contents input from the operation panel.

7. The information management system according to claim 1, further comprising:
a printing unit configured to be able to print the information list stored in the storage unit.

8. The information management system according to claim 1, further comprising:
a communicably coupled server device, wherein
the server device saves the information list stored in the storage unit into a data saving unit when receiving the information list.

9. The information management system according to claim 8, wherein
the server device
is configured to be able to use resident data, and
collates the information list with the resident data, and generates an unknown person list of residents who are not listed in the information list.

10. The information management system according to claim 8, wherein
the information list is configured to be able to be deleted from the storage unit after the information list is saved in the data saving unit.
